(19) United States
(12) Patent Application Publication
(10) Pub. No.: US 2024/0014695 A1
(43) Pub. Date: Jan. 11, 2024

(54) THREE-PHASE ASYNCHRONOUS MOTOR AND SPEED-REGULATED WATER PUMP

(71) Applicant: Zhejiang Dongxin iTechnology Co.,Ltd., Zhuji (CN)

(72) Inventors: GUOYAO WU, Zhuji (CN); DONG CHEN, Zhuji (CN); YUEJUN LUO, Zhuji (CN)

(21) Appl. No.: 17/867,943

(22) Filed: Jul. 19, 2022

(30) Foreign Application Priority Data
Jul. 7, 2022 (CN) 202210795153.4

(51) Int. Cl. H02K 1/14; H02K 1/16; H02K 1/26; H02K 3/28; H02K 5/22

(52) U.S. Cl. CPC H02K 1/148; H02K 1/165; H02K 1/265; H02K 3/28; H02K 5/225

(57) ABSTRACT

Three-phase asynchronous motor, comprising a housing and a stator assembly, which is fixedly arranged in the housing and is wound with coil, and further comprising a rotating shaft and a plurality of rotor punches, the shape and size of some of the rotor punches are the same, the rotor punches are sleeved and fixed on the rotating shaft, and located in holes of the stator assembly, a plurality of rotor slots are opened on the rotor punches, and shape and size of the all the rotor slots are the same. The rotor slot comprises a first, a second and a third slot portion. The first and the third slot portion are respectively located at both ends of the second slot portion. The first s and the third slot portion are semicircular; the second slot portion is in the shape of an isosceles trapezoid. The application discloses a speed-regulated water pump.

### CROSS-REFERENCE TO RELATED APPLICATIONS

This application claims the benefit and priority of Chinese patent application No. 202210795153.4, filed on Jul. 7, 2022, disclosure of which is hereby incorporated by reference in its entirety.

### TECHNICAL FIELD

The present application relates to the field of motor equipment, in particular to a three-phase asynchronous motor and a speed-regulated water pump.

### BACKGROUND

Electric motor is very important electrical equipment. Patent publication CN207082993 discloses a three-phase asynchronous motor, but the rotor components of the three-phase asynchronous motor are provided with rotor slots with different intervals. Since the lengths of the rotor slots are not equal, the machining procedure of the entire rotor assembly is relatively complicated, and since the rotor slots are waist-circular rotor slots, that is, the diameters of the two arcs are equal, the rotor slot of this structure will cause an air gap. The magnetic field distribution is uneven, and the waveform distortion is relatively large.

### SUMMARY

In order to solve the above problems, the present application discloses a three-phase asynchronous motor and a speed-regulated water pump.

A three-phase asynchronous motor, comprising a housing and a stator assembly, the stator assembly is fixedly arranged in the housing and the stator assembly is wound with coils, wherein further comprising a rotating shaft and a plurality of rotor punches, wherein shape and size of some of the rotor punches are the same, the rotor punches are sleeved and fixed on the rotating shaft, and the rotor punches are located in holes of the stator assembly, wherein a plurality of rotor slots are opened on the rotor punches, and shape and size of the all the rotor slots are the same, wherein the rotor slot comprises a first slot portion, a second slot portion and a third slot portion, and the first slot portion and the third slot portion are respectively located at both ends of the second slot portion, wherein the first slot portion and the third slot portion are configured in a shape of semicircle, the second slot portion is configured in a shape of an isosceles trapezoid, and the first slot portion is located at an upper base of the isosceles trapezoid, and the third portion is located at a lower base of the isosceles trapezoid, wherein a diameter of the first slot portion is equal to a length of the upper base of the isosceles trapezoid, and a diameter of the third slot portion is equal to a length of the lower base of the isosceles trapezoid, wherein the rotor slots are configured to be distributed in a circular ring on the rotor punch, and distance between two adjacent rotor slots is equal.

In the three-phase asynchronous motor of this structure, since all the rotor slots on the rotor punches have the same shape and size, and the rotor slots are distributed in a ring shape on the rotor punches, the distance between two adjacent rotor slots is equal. Therefore, in this type of motor, it can ensure that the air gap magnetic field is evenly distributed and the waveform distortion is relatively small.

At the same time, it should be noted that, in this type of rotor punch, the distance between the first slot portion and the center point of the ring is smaller than the distance between the third slot portion and the center point of the ring. This makes the rotor assembly more stable as it rotates.

Optionally, the stator assembly comprises a plurality of stator punches, and the stator punches are provided with a plurality of wire clamping openings, and the wire clamping openings are configured to distribute at equal distance and equal arc on the stator punches, the coils are clamped on the wire clamping openings, and the coil in each wire clamping opening is formed by winding multiple wires together.

Optionally, the stator punch is provided with a buckle slot.

Optionally, the hole in the stator assembly is a circular hole, and the rotor punch is provided with a shaft clamping hole, and the rotor punch is fixed on the rotating shaft through its own shaft clamping hole, and the rotor slots are configured to distribute at equal distance and equal arc around the rotating shaft.

Optionally, the three-phase asynchronous motor further comprises fan blades, the fan blades are mounted on the rotating shaft, and the fan blades are located in the housing.

Optionally, the three-phase asynchronous motor further comprises end covers, both ends of the housing are provided with the end cover, the end covers are provided with bearings, the rotating shaft is matched with the bearings.

Optionally, the housing is detachably provided with an wire outlet sheath and a button-type plug.

A speed-regulating water pump, comprising an above mentioned three-phase asynchronous motor, a pump casing, an impeller and a controller, wherein the impeller is installed in the pump casing, wherein the housing is matched with the pump casing, the rotating shaft is matched with the impeller, and the controller is electrically connected with the coils.

The present application has the following beneficial effects: all the rotor slots on the rotor punches have the same shape and size, and the rotor slots are distributed in a circular ring on the rotor punch, and the distance between two adjacent rotor slots is equal, which can ensure that the air gap magnetic field is evenly distributed and the waveform distortion is relatively small.

### BRIEF DESCRIPTION OF DRAWINGS

FIG. 1 is a schematic diagram of the structure of a three-phase asynchronous motor,

FIG. 2 is a schematic diagram of the structure of the rotor punch,

FIG. 3 is a schematic diagram of the structure of the rotor slot,

FIG. 4 is the schematic diagram of the structure of stator punch;

FIG. 5 is a schematic diagram of the structure of the wire clamping opening;

FIG. 6 is a schematic diagram of the winding relationship of the coil on the stator;

FIG. 7 is a schematic diagram of the structure of the speed-regulating water pump.

### The reference signs in the Figures are:

1. Rotating shaft; 2. End cover; 3. Screw; 4. Rotor assembly; 401. Rotor punch; 4011. Rotor slot; 40111. First slot portion; 40112. Second slot portion; 40113. Third slot portion; 4012. Shaft clamping hole; 5. Stator assembly; 501. Stator punch; 5011. Wire clamping opening; 5012. Buckle slot; 5013. Connecting hole; 6. Wire outlet sheath; 7. Button.-type plug; 8. Bearing; 9. Housing; 10. Fan blade; 11. Cover; 12. Pump casing; 13. Controller.

### DETAILED DESCRIPTION

In the following, the technical solutions of the present application will be described clearly and completely through specific embodiments with reference to the accompanying drawings.

### Embodiment 1

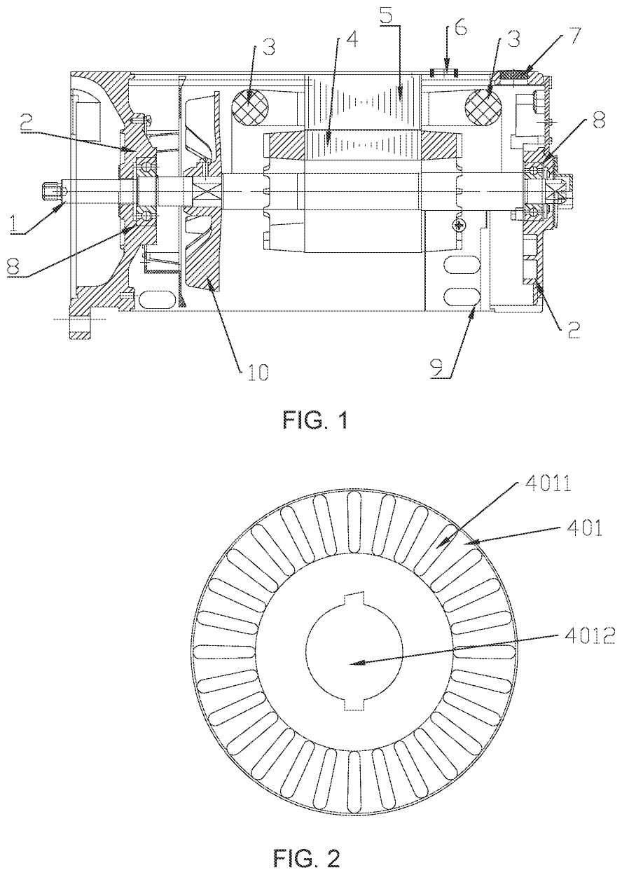

Referring to FIG. 1, FIG. 2 and FIG. 4, a three-phase asynchronous motor comprises a housing 9 and a stator assembly 5, the stator assembly 5 is fixedly arranged in the housing 9 and the stator assembly 5 is wound with coils, wherein further comprises a rotating shaft 1 and a plurality of rotor punches 401, wherein the rotor punches 401 are sleeved and fixed on the rotating shaft 1, and the rotor punches 401 are located in holes of the stator assembly 5, wherein a plurality of rotor slots 4011 are opened on the rotor punches 401, and shape and size of the all the rotor slots 4011 are the same, wherein the rotor slot 4011 comprises a first slot portion 40111, a second slot portion 40112 and a third slot portion 40113, and the first slot portion 40111 and the third slot portion 40113 are respectively located at both ends of the second slot portion 40112, wherein the first slot portion 40111 and the third slot portion 40113 are configured in a shape of semicircle, the second slot portion 40112 is configured in a shape of an isosceles trapezoid, and the first slot portion 40111 is located at an upper base of the isosceles trapezoid, and the third portion 40113 is located at a lower base of the isosceles trapezoid, wherein a diameter of the first slot portion 40111 is equal to a length of the upper base of the isosceles trapezoid, and a diameter of the third slot portion 40113 is equal to a length of the lower base of the isosceles trapezoid, wherein the rotor slots 4011 are configured to be distributed in a circular ring on the rotor punch 401, and distance between two adjacent rotor slots 4011 is equal.

In the three-phase asynchronous motor of this structure, the rotor slots 4011 are in a shape of circular ring, since all the rotor slots 4011 on the rotor punches 401 have the same shape and size, and the rotor slots 4011 are distributed in a ring shape on the rotor punches, the distance between two adjacent rotor slots 4011 is equal. Therefore, in this type of motor, it can ensure that the air gap magnetic field is evenly distributed and the waveform distortion is relatively small.

At the same time, it should be noted that, in this type of rotor punch 401, the distance between the first slot portion 40111 and the center point of the ring is smaller than the distance between the third slot portion 40113 and the center point of the ring. That is, the outer side of the rotor slot 401 is wide and the inner side is narrow, which is a structure in which the outer side is wide and the inner side is narrow. Compared with the structure that is narrow on the outside and wide on the inside, it can make the motor work with higher efficiency.

At the same time, the first slot portion 40111 and the third slot portion 40113 are located on both sides of the second slot portion 40112, and the first slot portion 40111 and the third slot portion 40113 respectively block the second slot portion 40112 from both sides, so that the entire rotor slot 4011 is equivalent to a closed slot. The closed rotor slot 4011 can improve the air gap magnetic field and the harmonic pulse of the magnetic field when rotating, which can reduce the effective air gap of the motor and reduce the stray loss of the motor.

The stator assembly 5 comprises a plurality of stator punches 501 as shown in FIG. 4, and the stator punches 501 are provided with a plurality of wire clamping openings 5011, and the wire clamping openings 5011 are configured to distribute at equal distance and equal arc on the stator punches 501, the coils are clamped on the wire clamping openings 5011, and the coil in each wire clamping opening 5011 is formed by winding multiple wires together. The stator punches 501 are provided with connecting holes 5013, and bolts connecting all the stator punches 501 together pass through the connecting holes 5013 on the stator punches 501.

Referring to FIG. 6, the coil is formed by winding multiple wires together. Compared with the coil wound by a single wire, under the condition of the same conductive cross-sectional area, the coil formed by winding multiple wires together is easier to be stuck in the wire clamping opening 5011 due to the smaller diameter of the single wire.

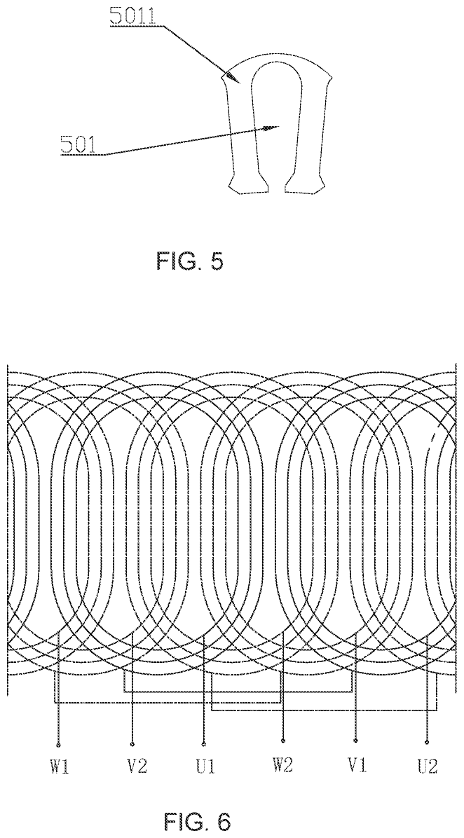

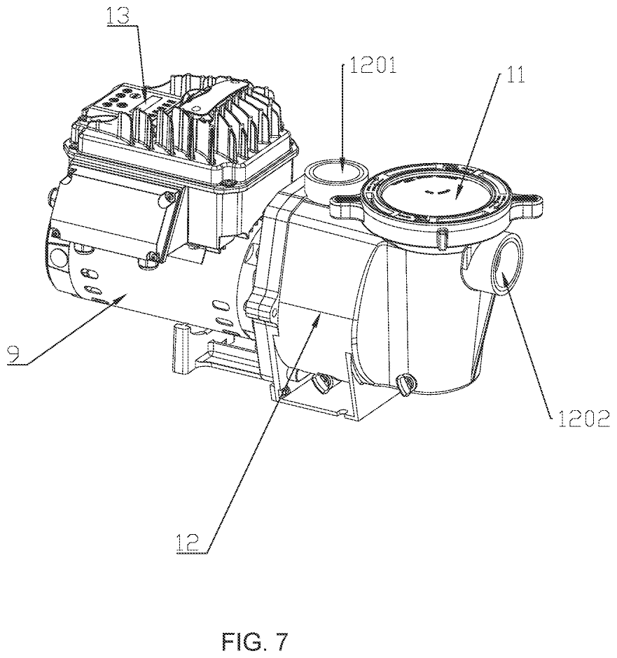

Referring to FIGS. 4 and 5, in the wire clamping opening 5011 of the stator punch 501 of this type, the opening of the entire wire clamping opening 5011 is the narrowest part of the entire wire clamping opening 5011, and the coil is clamped into the wire clamping opening 5011 through the opening of the wire clamping opening 5011, which can improve the stability of the coil in the wire clamping opening 5011 and reduce the probability of the coil falling off the wire clamping opening 5011.

The stator punch 501 is provided with a buckle slot 5012.

By opening the buckling slot 5012 on the stator punch 501., the stator punch 501 can be easily snapped and fixed in the housing 9 through its own buckle slot 5012.

At the same time, the existence of the buckle slot 5012 will sacrifice part of the starting torque. By sacrificing part of the starting torque, leakage reactance can be appropriately increased, current harmonics can be reduced, and additional losses can be reduced.

The hole in the stator assembly 5 is a circular hole, and the rotor punch 401 is a circular rotor punch 401. Specifically, the stator is provided with connecting holes 5013, so that connecting parts such as bolts can fasten all the stator punches 501 together through the connecting holes 5013.

The rotor punch 401. is provided with a shaft clamping hole 4012, and the rotor punch 401 is fixed on the rotating shaft 1 through its own shaft clamping hole 4012, and the rotor slots 4011 are configured to distribute at equal distance and equal arc around the rotating shaft 1.

The shaft clamping hole 4012 on the rotor punch 401 is not a circular shaft clamping hole 4012, and the matching part of the rotating shaft 1 and the rotor punch 401 is not a cylindrical structure.

As an optional embodiment, the shaft clamping hole 4012 can be a circular hole with a notch or a circular hole with an irregular hole at the edge, and the matching part of the rotating shaft 1 only needs to ensure that the rotor punch 401 can be stuck on the rotating shaft 1.

It also comprises fan blades 10, the fan blades 10 are installed on the rotating shaft 1, and the fan blades 10 are located in the housing 9.

Fan blades are arranged on the rotating shaft 1, so that the rotating shaft 1 drives the fan blades to rotate so as to dissipate heat to the stator assembly 5 and the rotor assembly 4. The specific fan blades are cast aluminum fan blades.

In this embodiment, the fan blades are cast by using metal aluminum, and other metal materials can also be selected for casting in other embodiments. In this embodiment, the fan blades 10 can be fixed on the rotating shaft 1 by clips, or can be fixed on the rotating shaft 1 by bolts or screws, or can be fixed on the rotating shaft by a circlip.

It also comprises end covers 2, both ends of the housing 9 are provided with the end covers 2, the end covers 2 are provided with bearings 8, and the rotating shaft 1 is matched with the bearing 8.

The end covers 2 can be detachably mounted on the housing 9 by means of fasteners such as screws or pins, or the end cover 2 and the housing 9 may also be directly fitted together by means of screw fitting, or may be connected by means of a snap or the like.

In this embodiment, lubricating oil needs to be smeared between the bearing 8 and the rotating shaft 1 to reduce the wear of the bearing and the rotating shaft,

The housing 9 is detachably provided with a wire outlet sheath 6 and a button-type plug 7.

The purpose of providing the wire outlet sheath 6 is to facilitate the fixing of the wire, and the button plug 7 is pluggably installed on the housing 9. This design facilitates quick maintenance of the equipment in the housing 9 as required.

The shape of the rotor slot 4011 and the shape of the wire clamping opening 5011 adopted in this embodiment can reduce the tooth harmonic low-order force wave order of the stator assembly 5, avoid the low-order force wave resonance, reduce the vibration and noise of the motor, and improve the motor efficiency.

In this embodiment, the diameter of the third slot portion 40113 is 1.2 times the diameter of the first slot portion 40111, and the height of the second slot portion 40112 is 8.8 times the diameter of the first slot portion 40111.

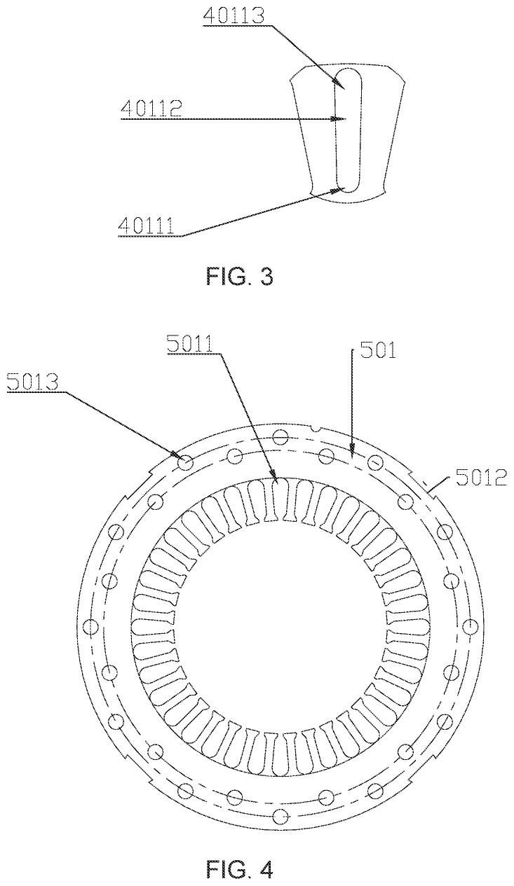

Referring to FIGS. 2 and 3, the rotor assembly 4 provided in this embodiment is in a structure with a width in the middle and narrow at both ends. Therefore, not all the rotor punches 401 in the rotor punches 401 used in this embodiment are of the same size. The rotor punches 401 in the middle section of the rotor assembly 4 are large in size, while the rotor punches 401 at both ends of the rotor assembly 4 are small in size. The diameters of the rotor punches 401 shown in this embodiment are not equal, the diameter of the rotor punches 401 located in the middle of the intermediate rotor assembly 4 is large, and the diameter of the rotor punches 401 located at the edges is relatively small.

In this embodiment, the winding distribution of the coils in the stator assembly 5 is shown in FIG. 6, and W, U, and V marked in FIG. 6 respectively represent three phases.

Referring to FIG. 1, in this embodiment, the housing 9 is fixed with screws 3, and the screws 3 are used to ensure the strength and stability of the housing 9 and ensure that the housing 9 does not fall apart.

In this embodiment, components such as the housing 9 and the end cover 2 are made of metal. In other equivalent embodiments, non-metallic materials with sufficient strength and high height such as engineering plastics can also be used.

### Embodiment 2

The three-phase asynchronous motor shown in this embodiment is similar to that in Embodiment 1, the difference is that the three-phase asynchronous motor provided in this embodiment discloses the specific numerical parameters of each part. There are 28 rotor slots 4011 on the rotor punch 401. The diameter of the first slot portion 40111 is 1.45 mm, and the diameter of the third slot portion 40113 is 1.75 mm. The height of the second slot portion 40112 in the shape of an isosceles trapezoid is 8.8 mm. The diameter of the rotor punch 401 is 84 mm. The rotor punch 401 is located in the hole of the stator assembly 5, and the stator assembly 5 is composed of several stator punches 501. The outer diameter of the stator punch 501 is 160 mm, and the distance between the outer edge of the rotor punch 401 and the hole wall of the stator assembly 5 is 0.3 mm. Each stator punch 501 is provided with 36 wire clamping openings 5011. The coils in each wire clamping opening 5011 are wound by three copper wires with a diameter of 0.9 mm, and the number of turns of the coil is 18. The rotating shaft 1 is a stepped rotating shaft 1, the diameter of the part where the rotating shaft 1 and the rotor punch 401 are fixed together is 25 mm, and the length of the rotating shaft 1 is 364 mm.

The three-phase asynchronous motor provided in this embodiment is measured and calculated, and the motor efficiency is 86%, and the phase resistance is 0.513 ohms when the temperature is 20°0 C.

The motor provided in this embodiment adapts to a three-phase power with a frequency of 60 Hz and a voltage of 230 V.

### Embodiment 3

This embodiment provides a speed-regulated water pump, comprising the above-mentioned three-phase asynchronous motor, a pump casing, an impeller and a controller, and the impeller (not shown in the Figures) is installed in. the pump casing. When the cover 11 on the pump casing 12 is removed, the impeller located in the pump easing 12 can be seen. The housing 9 is fixedly fitted with the pump casing 12, and the rotating shaft 1 is fitted with the impeller. The pump casing 12 is provided with a water inlet 1201 and a water outlet 1202. When the three-phase asynchronous motor drives the impeller to rotate, the rotation of the impeller can draw water from the water inlet and then discharge it from the water outlet. The controller 13 is electrically connected with the coil, and the controller is provided with four speed buttons. The corresponding speeds of the four speed buttons are 3450 rpm, 2800 rpm, 1700 rpm and 1200 rpm, respectively. The above speeds +/−200 r/min are all used as the protection scope of this embodiment, When the user selects the highest speed of 3450 rpm, the user can choose to automatically switch to the next high speed 2800 rpm within any time period from 2 to 24 hours and then continue to run (For example, it will automatically switch to 2800 rpm after 2 hours of operation at 3450 rpm; it can also be automatically switched to 2800 rpm after 12 hours of operation at 3450 rpm; but automatically within 24 hours of operation at 3450 rpm switch to 2800 rpm).

As a further optional implementation, a timing module can also be set in the controller, which can make the three-phase asynchronous motor work at a certain speed for a certain period of time and then automatically stop or can jump to a slower or any other rotational speed under the premise that the maximum speed does not exceed 24 hours at most. As an optional variant implementation, a programmable module can be further set inside the controller, so that the working state of the entire speed-regulated water pump can be regulated by programming. Of course, the controller 13 can also have a built-in wireless communication module, which is convenient for controlling the controller by remote control, and also convenient for the controller to send the running parameters of the entire speed-regulating water pump through the wireless communication module. Of course, a data cable interface can also be set on the controller, so that it is convenient to connect other devices through the data cable.

In this embodiment, a storage module may be further set on the controller, and the storage module is used to store the operation parameters of the entire speed-regulated water pump at each moment during operation.

The power of the speed-regulating water pump provided in this embodiment may be 1.5 horsepower or 2 horsepower or 3 horsepower.

Although the present application has been disclosed above with preferred embodiments, it is not intended to limit the present application. Any person skilled in the art can make possible changes and modifications to the technical solutions of the present application by utilizing the methods and technical contents disclosed above without departing from the spirit and scope of the present application. Therefore, any simple modifications, equivalent changes and modifications made to the above embodiments according to the technical essence of the present application without departing from the content of the technical solutions of the present application belong to the protection scope of the technical solutions of the present application.

What is claimed is:

1. A three-phase asynchronous motor, comprising a housing and a stator assembly, the stator assembly is fixedly arranged in the housing and the stator assembly is wound with coils, wherein further comprising a rotating shaft and a plurality of rotor punches, wherein shape and size of some of the rotor punches are the same, the rotor punches are sleeved and fixed on the rotating shaft, and the rotor punches are located in holes of the stator assembly, wherein a plurality of rotor slots are opened on the rotor punches, and shape and size of the all the rotor slots are the same, wherein the rotor slot comprises a first slot portion, a second slot portion and a third slot portion, and the first slot portion and the third slot portion are respectively located at both ends of the second slot portion, wherein the first slot portion and the third slot portion are configured in a shape of semicircle, the second slot portion is configured in a shape of an isosceles trapezoid, and the first slot portion is located at an upper base of the isosceles trapezoid, and the third portion is located at a lower base of the isosceles trapezoid, wherein a diameter of the first slot portion is equal to a length of the upper base of the isosceles trapezoid, and a diameter of the third slot portion is equal to a length of the lower base of the isosceles trapezoid, wherein the rotor slots are configured to be distributed in a circular ring on the rotor punch, and distance between two adjacent rotor slots is equal, wherein the rotor punch is configured in the shape of a ring, and distance between the first slot portion and a center point of the ring is smaller than distance between the third slot portion and the center point of the ring.

2. three-phase asynchronous motor according to claim 1, wherein the stator assembly comprises a plurality of stator punches, and the stator punches are provided with a plurality of wire clamping openings, and the wire clamping openings are configured to distribute at equal distance and equal arc on the stator punches, and the coils are clamped on the wire clamping openings, and the coil in each wire clamping opening is formed by winding multiple wires together, wherein the opening of the wire clamping opening is the narrowest part of the entire wire clamping opening.

3. three-phase asynchronous motor according to claim 2, wherein the stator punch is provided with a buckle slot.

4. three-phase asynchronous motor according to claim 1, wherein the hole in the stator assembly is a circular hole.

5. three-phase asynchronous motor according to claim 1, wherein the rotor punch is provided with a shaft clamping hole, and the rotor punch is fixed on the rotating shaft through its own shaft clamping hole, and the rotor slots are configured to distribute at equal distance and equal arc around the rotating shaft.

6. three-phase asynchronous motor according to claim 1, further comprising fan blades, the fan blades are mounted on the rotating shaft, and the fan blades are located in the housing.

7. three-phase asynchronous motor according to claim 1, further comprising end covers, both ends of the housing are provided with the end cover, the end covers are provided with bearings, the rotating shaft is matched with the bearings.

8. three-phase asynchronous motor according to claim 2, wherein the housing is detachably provided with an wire outlet sheath and a button-type plug.

9. A speed-regulating water pump, comprising a three-phase asynchronous motor according to claim 1, a pump casing, an impeller and a controller, wherein the impeller is installed in the pump casing, wherein the housing is matched with the pump casing, the rotating shaft is matched with the impeller, and the controller is electrically connected with the coils.
